(19) United States
(12) Patent Application Publication
(10) Pub. No.: US 2023/0240365 A1
(43) Pub. Date: Aug. 3, 2023

(54) HEATING ASSEMBLY, ATOMIZER AND ELECTRONIC CIGARETTE

(71) Applicant: Shenzhen Smiss Technology Co. Ltd, Shenzhen (CN)

(72) Inventor: Jiatai CHEN, Irvine, CA (US)

(73) Assignee: Shenzhen Smiss Technology Co. Ltd, Shenzhen (CN)

(21) Appl. No.: 17/743,467

(22) Filed: May 13, 2022

Related U.S. Application Data
(60) Provisional application No. 63/304,624, filed on Jan. 30, 2022.

(30) Foreign Application Priority Data
Mar. 24, 2022 (CN) 202210296451.9
Mar. 24, 2022 (CN) 202220659265.2

(51) Int. Cl. A24F 40/46; A24F 40/44; A24F 40/10; A24F 40/485; A24F 40/42; H05B 3/24

(52) U.S. Cl. CPC A24F 40/46; A24F 40/44; A24F 40/10; A24F 40/485; A24F 40/42; H05B 3/24; H05B 2203/016

(57) ABSTRACT

A heating assembly for an atomizer includes a resistive heating plate and an atomizing bracket. The resistive heating plate is combined with the atomizing bracket. The resistive heating plate includes a flat plate portion and a hollowed portion. The atomizing bracket includes an atomizing opening. The atomizing opening is aligned with the hollowed portion. The present disclosure further provides an atomizer and an electronic cigarette.

### TECHNICAL FIELD

The present disclosure relates to the technical field of electronic atomization, and in particular, to a heating assembly, an atomizer, and an electronic cigarette with the atomizer.

### BACKGROUND

Atomizer is the core part of electronic atomization products. The quality reliability of the atomizer determines the quality of the whole atomization product.

One of the existing atomizing structures is: the surface of ceramic porous material is printed and covered with heating slurry or the surface is embedded with metal resistive heating body. In both methods, porous ceramics are used as the oil conducting material to absorb smoke oil to the surface of the resistive heating body, which generates heat when the resistive heating body is energized, so as to atomize the smoke oil. The atomizing structures made by these methods have complex ceramic molding process, low yield and poor consistency of ceramics, so they have the disadvantages of high product cost, slightly poor oil conductivity of ceramics to easily produce burning smell, and slightly poor taste reduction.

Another existing atomizing structure is: the surface of a transverse cotton core is wrapped with a spiral resistive heating wire, the transverse cotton core absorbs the smoke oil to the surface of the resistive heating wire, and generates heat when the resistive heating wire is energized, so as to atomize the smoke oil. The transverse cotton core of the atomizing structure in this way is very easy to deform, resulting in difficult assembly, and the long oil guide distance is easy to produce burning smell.

A further existing atomizing structure is: the external surface of the resistive heating body of a vertical cotton core is wrapped with oil guide cotton, and the internal side of the resistive heating body is hollow. The oil guide cotton wrapped on the surface absorbs the smoke oil to the surface of the resistive heating body, and generates heat when the resistive heating body is energized, so as to atomize the smoke oil. The vertical cotton core of the atomizing structure in this way consists of many parts with complex assembly, resulting in high product cost.

From above, the existing atomizing structures fail to meet the requirements of the stability of product quality and automatic production.

### SUMMARY

In view of the above, the object of the present disclosure is to provide a heating assembly and an atomizer with high quality stability and capable of automatic production and assembly, so as to at least partially solve the problems of poor consistency of product quality, difficult assembly and high cost.

An embodiment of the present disclosure provides a heating assembly for an atomizer. The heating assembly includes a resistive heating plate and an atomizing bracket. The resistive heating plate is combined with the atomizing bracket. The resistive heating plate includes a flat plate portion and a hollowed portion. The atomizing bracket includes an atomizing opening. The atomizing opening is aligned with the hollowed portion.

An embodiment of the present disclosure further provides an atomizer. The atomizer includes an atomizing bracket, a resistive heating plate and an oil guiding member. The resistive heating plate is combined with the atomizing bracket. The resistive heating plate includes a flat plate portion and a hollowed portion. The atomizing bracket includes an atomizing opening. The resistive heating plate includes a first surface facing the oil guiding member and a second surface away from the oil guiding member. The oil guiding member includes a third surface facing the resistive heating plate and a fourth surface away from the resistive heating plate. The oil guiding member is disposed on the resistive heating plate, the third surface of the oil guiding member is in contact with the first surface of the resistive heating plate, and the atomizing opening is aligned with the hollowed portion.

An embodiment of the present disclosure further provides an electronic cigarette. The electronic cigarette includes the above-mentioned atomizer.

In the heating assembly and atomizer provided by the embodiment of the present disclosure, the resistive heating plate is combined with the atomizing bracket to form a heating assembly. Such a heating assembly can be assembled simply and can realize automatic assembly and production, to effectively improve the production efficiency and product stability, and effectively ensure the quality consistency of the atomizing structure. At the same time, the oil guiding member is in full and close contact with the resistive heating plate of the heating assembly, thereby effectively improving the atomization effect and avoiding the generation of burning smell to affect the taste of smoking during atomization.

### BRIEF DESCRIPTION OF THE DRAWINGS

FIG. 1 is a partially exploded view of an atomizer according to a first embodiment of the present disclosure.

FIG. 2 is a fully exploded view of the atomizer in FIG. 1.

FIG. 3 is a fully exploded view of the atomizer in FIG. 1 from a different viewing angle.

FIG. 4 is a top view of the atomizer in FIG. 1.

FIG. 5 is a cross-sectional view of the atomizer along line A-A in FIG. 4.

FIG. 6 is a cross-sectional view of the atomizer along line B-B in FIG. 4.

FIG. 7 is an exploded view of the heating assembly and the oil guiding member of the atomizer in FIG. 1.

FIG. 8 is a view showing the assembly of the heating assembly and the oil guiding member in FIG. 7.

FIG. 9 is another view of the heating assembly and the oil guiding member in FIG. 8.

FIG. 10 is a structural diagram when two ends of the resistive heating plate have not been bent to form the conductive pins after the resistive heating plate is embedded and combined with the atomizing bracket.

FIG. 11 is a cross-sectional view along line C-C after the assembly of the heating assembly and the oil guiding member in FIG. 8.

FIG. 12 is an exploded view of an atomizer according to a second embodiment of the present disclosure.

FIG. 13 is a top view of the atomizer in FIG. 12 after assembly.

FIG. 14 is a cross-sectional view of the atomizer along line D-D in FIG. 13.

FIG. 15 is a schematic diagram showing the airflow direction inside the atomizer in FIG. 14.

FIG. 16 is an assembly diagram of the resistive heating plate, the atomizing bracket and the atomizing base of the atomizer in FIG. 12.

FIG. 17 is an exploded view of FIG. 16.

FIG. 18 is another view of FIG. 16 from a different viewing angle.

FIG. 19 is an exploded view of FIG. 18.

FIG. 20 is a schematic diagram of the resistive heating plate of the atomizer in FIG. 12.

FIG. 21 is another view of FIG. 20 from a different viewing angle.

### DETAILED DESCRIPTION OF PREFERRED EMBODIMENTS

The technical solutions in the embodiments of the present disclosure will be clearly and completely described below with reference to the accompanying drawings in the embodiments of the present disclosure. Obviously, the described embodiments are only part of the embodiments of the present disclosure, not all of the embodiments. Based on the embodiments of the present disclosure, all other embodiments obtained by ordinary technicians in the art without creative work belong to the protection scope of the present disclosure.

It should be noted that in this disclosure, relational terms such as “first” and “second” are only used to distinguish one entity or operation from another entity or operation, and do not necessarily require or imply any such actual relationship or order between these entities or operations.

### First Embodiment

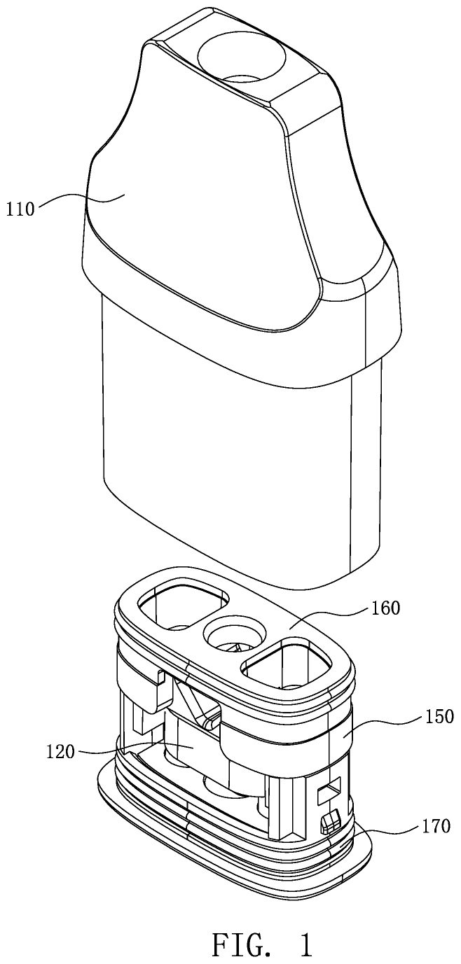

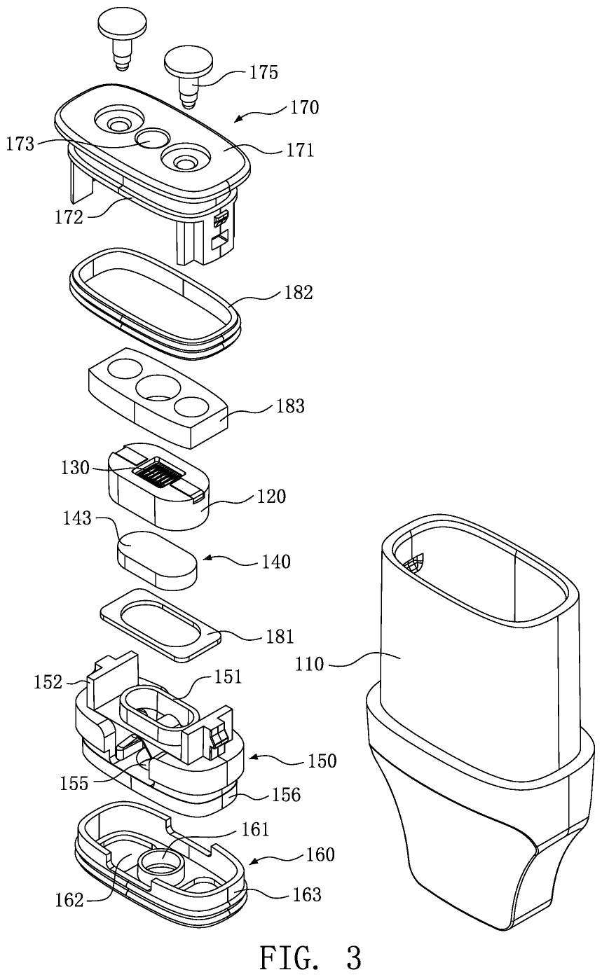

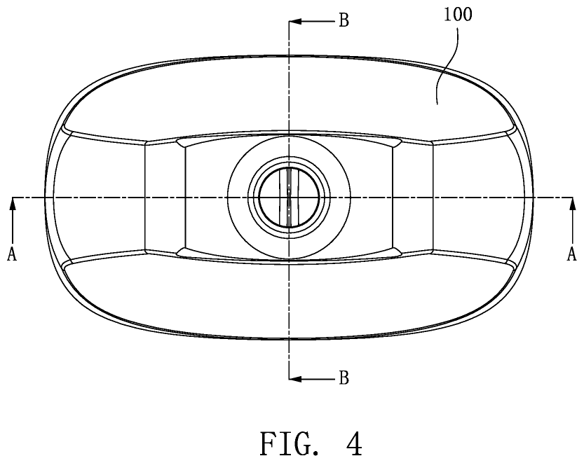

Referring to FIGS. 1 to 6. a first embodiment of the present disclosure provides an atomizer 100, which includes an oil storage container 110, an atomizing bracket 120, a resistive heating plate 130 and an oil guiding member 140, wherein the atomizing bracket 120, the resistive heating plate 130 and the oil guiding member 140 are received in the oil storage container 110.

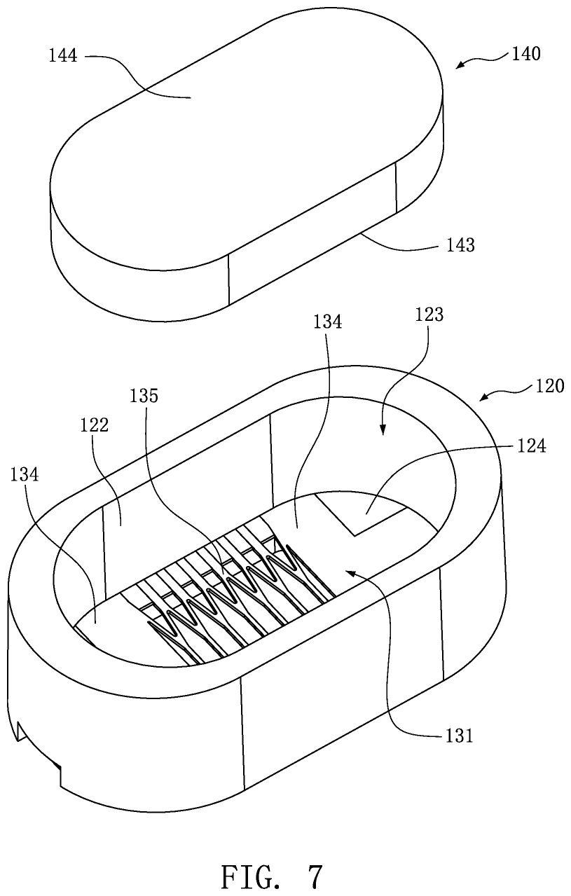

Referring to FIGS. 7 to 11, the resistive heating plate 130 is combined with the atomizing bracket 120, and the oil guiding member 140 is disposed on the resistive heating plate 130. The resistive heating plate 130 has a sheet structure, and the resistive heating plate 130 is made of a metal sheet. The resistive heating plate 130 includes a flat plate portion 134, a hollowed portion 135, a first surface 131 facing the oil guiding member 140 and a second surface 132 away from the oil guiding member 140, wherein the first surface 131 is the upper surface of the resistive heating plate 130 and the second surface 132 is the lower surface of the resistive heating plate 130. The atomizing bracket 120 includes an atomizing opening 126, and the atomizing opening 126 is aligned with the hollowed portion 135. The oil guiding member 140 includes a third surface 143 facing the resistive heating plate 130 and a fourth surface 144 away from the resistive heating plate 130, wherein the third surface 143 is the lower surface of the oil guiding member 140 and the fourth surface 144 is the upper surface of the oil guiding member 140. The third surface 143 of the oil guiding member 140 is in contact with the first surface 131 of the resistive heating plate 130.

In this embodiment, the resistive heating plate 130 is combined with the atomizing bracket 120, and then the oil guiding member 140 is directly in contact with the resistive heating plate 130. In this way, the assembly is simple, and the automatic assembly and production can be realized, which can effectively improve the production efficiency and product stability, and effectively ensure the quality consistency of the atomizing structure. Further, the resistive heating piece 130 is in full and close contact with the oil guiding member 140, which can effectively improve the atomization effect and avoid the influence of burning smell to affect the taste of smoking during atomization.

Referring to FIGS. 7-11, specifically, the first surface 131 and the second surface 132 of the resistive heating plate 130 are flat surfaces, and the first surface 131 and the second surface 132 are parallel to each other. The oil guiding member 140 has a block structure, the third surface 143 and the fourth surface 144 of the oil guiding member 140 are flat surfaces, and the third surface 143 and the fourth surface 144 are parallel to each other. The oil guiding member 140 can cause the smoke oil to be evenly absorbed and transmitted to the resistive heating plate 130, so as to improve the atomization effect. The oil guiding member 140 may be an oil guide cotton.

A plurality of orifices 133 are provided in the middle of the resistive heating plate 130 to form the hollowed portion 135, so that the resistive heating plate 130 forms two flat plate portions 134 and the hollowed portion 135, and the hollowed portion 135 is located in the middle of the resistive heating plate 130. The two flat plate portions 134 and the hollowed portion 135 are located in the same plane, the two flat plate portions 134 are respectively located on two opposite sides of the hollowed portion 135, the hollowed portion 135 is located between the two flat plate portions 134, and the two flat plate portions 134 are interconnected by the hollowed portion 135. The hollowed portion 135 forms a plurality of heating wires between adjacent orifices 133, and thus the hollowed portion 135 is the heating part of the resistive heating plate 130. The smoke generated by atomization can enter the airflow channel in the atomizer 100 through these orifices 133 and be taken away by the external air entering the atomizer 100 for the user to inhale.

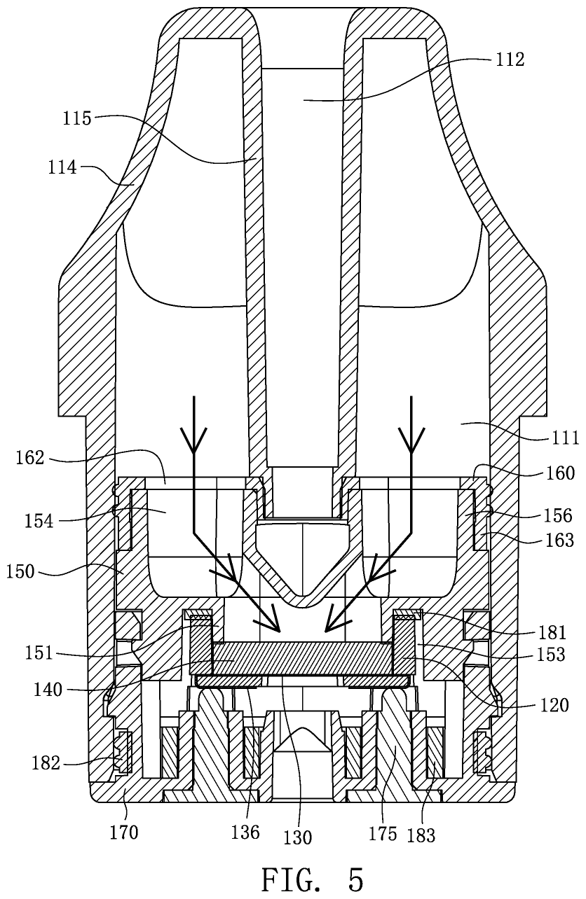

The resistive heating plate 130 further includes two conductive pins 136 arranged respectively corresponding to the two flat plate portions 134, and each conductive pin 136 is electrically connected with a corresponding flat plate portion 134. In this embodiment, each conductive pin 136 and the corresponding flat plate portion 134 are separated from each other by the atomizing bracket 120, and each conductive pin 136 is connected with the corresponding flat plate portion 134 through a bending portion 139. The two conductive pins 136 are each located at the lower surface of the atomizing bracket 120 and exposed outside the atomizing bracket 120, and the two conductive pins 136 are each in contact with the lower surface of the atomizing bracket 120. In this embodiment, the two conductive pins 136 extend respectively from two ends of the resistive heating plate 130 to the outside of the atomizing bracket 120, and are formed by bending downward and inward. Specifically, the two conductive pins 136 are formed by bending downward and inward from the outside of the two flat plate portions 134 respectively. Each conductive pin 136 is exposed on the lower surface of the atomizing bracket 120, so that it is convenient to realize the electrical connection with the conductive electrode 175 (see FIG. 5) through the exposed conductive pin 136.

The resistive heating plate 130 is made of metal, for example, the material of the resistive heating plate 130 may be nickel chromium alloy, iron chromium aluminum, S316L stainless steel, or other alloy materials. The atomizing bracket 120 is made of plastic, rubber or silicone. The resistive heating plate 130 is combined with the atomizing bracket 120 through an insert molding process. Specifically, when forming the atomizing bracket 120, the resistive heating plate 130 is placed in a cavity of a mold (not shown), and then molten plastic, rubber or silicone is injected into the cavity of the mold, so that the molten plastic, rubber or silicone is coated on the periphery of the resistive heating plate 130, and after cooling, the atomizing bracket 120 is formed, so that the resistive heating plate 130 is at least partially embedded in the atomizing bracket 120, and the bottom surface and outer edges of the two flat plate portions 134 and the outer edge of the hollowed portion 135 are integrated with the atomizing bracket 120.

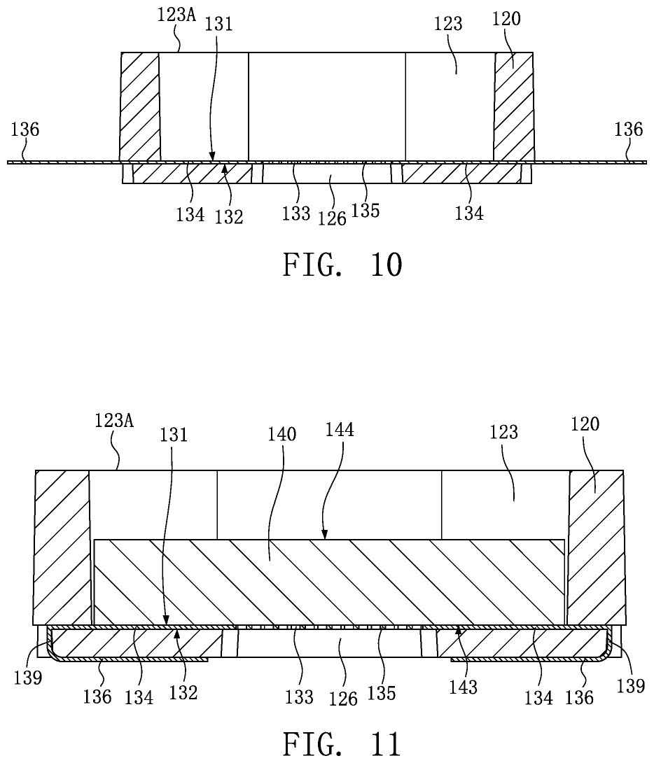

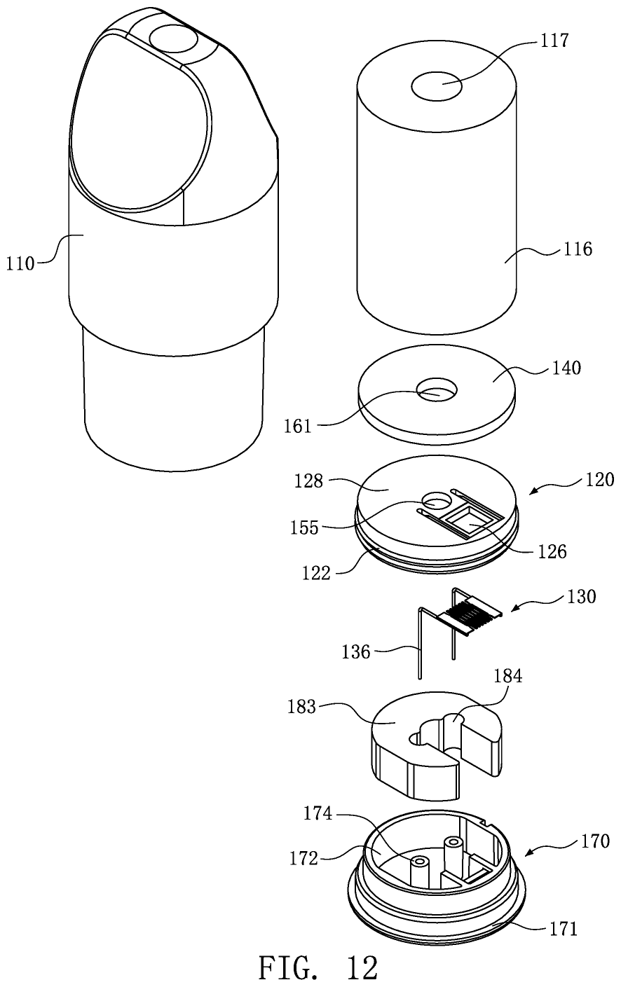

Referring to FIG. 10 and FIG. 11, after the resistive heating plate 130 is embedded into the atomizing bracket 120 by insert molding process, two ends of the resistive heating plate 130 extend horizontally out of the atomizing bracket 120 (see FIG. 10). Then, a tool (not shown) is used to bend two ends of the resistive heating plate 130 downward and inward to form the two conductive pins 136 (see FIG. 11). The two conductive pins 136 are respectively connected with the two flat plate portions 134 through the bending portions 139 and are respectively exposed under the two flat plate portions 134. Each conductive pin 136 is in contact with the lower surface of the bottom plate 121 of the atomizing bracket 120.

The resistive heating plate 130 is combined with the atomizing bracket 120 to form a heating assembly.

Referring to FIGS. 7-11, the atomizing bracket 120 includes a bottom plate 121 and a side wall 122 extending upward from the periphery of the bottom plate 121. A receiving cavity 123 is formed in the atomizing bracket 120. The receiving cavity 123 is surrounded by the bottom plate 121 and the side wall 122 of the atomizing bracket 120, and the upper end of the receiving cavity 123 is formed with an opening 123A. The atomizing opening 126 is arranged in the middle of the bottom plate 121 and penetrates the upper and lower surfaces of the bottom plate 121. The atomizing opening 126 is aligned with the hollowed portion 135. That is, the hollowed portion 135 is arranged at the position corresponding to the atomizing opening 126 so that the hollowed portion 135 is aligned with the atomizing opening 126. The atomizing opening 126 is in communication with the receiving cavity 123. The hollowed portion 135 is exposed and located above the atomizing opening 126, and the hollowed portion 135 spans over the atomizing opening 126.

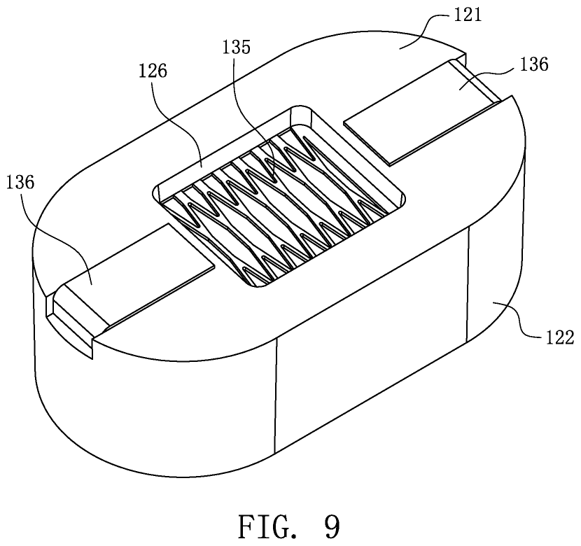

Referring to FIG. 9 and FIG. 11, the second surface 132 of the resistive heating plate 130 is higher than the lower surface of the bottom plate 121 of the atomizing bracket 120, and a specific distance is formed between them, preferably 0.5 mm-2.0 mm.

The outline of the oil guiding member 140 matches the shape of the receiving cavity 123, and the oil guiding member 140 is placed in the receiving cavity 123 through the opening 123A at the upper end of the receiving cavity 123. The oil guiding member 140 is smoothly arranged in the receiving cavity 123 of the atomizing bracket 120. The oil guiding member 140 is arranged independently of the atomizing bracket 120 and the resistive heating plate 130. The oil guiding member 140 is removably received in the receiving cavity 123, that is, the oil guiding member 140 can be placed into or removed from the receiving cavity 123. The oil guiding member 140 has the ability to absorb smoke oil, but the atomizing bracket 120 does not have the ability to absorb smoke oil. The atomizing bracket 120 is used to combine the resistive heating plate 130 and accommodate and support the oil guiding member 140. By limiting the oil guiding member 140 in the receiving cavity 123, the smoke oil absorbed into the receiving cavity 123 through the oil guiding member 140 can only be supplied downward to the resistive heating plate 130 for atomization, which can effectively prevent the leakage of the smoke oil and the splashing during atomization.

Referring to FIG. 7 and FIG. 11, the bottom plate 121 of the atomizing bracket 120 includes a bearing surface 124 in contact with the third surface 143 of the oil guiding member 140. Specifically, the bearing surface 124 is the upper surface of the bottom plate 121. The first surface 131 of the resistive heating plate 130 is located in the same plane with the upper surface of the bottom plate 121, that is, the upper surface of the hollowed portion 135 is located in the same plane with the upper surface of the bottom plate 121, and the upper surface of each flat plate portion 134 is located in the same plane with the upper surface of the bottom plate 121. The first surface 131 of the resistive heating plate 130 is exposed outside the bottom plate 121 of the atomizing bracket 120, that is, the upper surface of the hollowed portion 135 and the upper surface of each flat plate portion 134 are exposed outside the bottom plate 121 of the atomizing bracket 120. When the oil guiding member 140 is placed in the receiving cavity 123, the third surface 143 of the oil guiding member 140 is in contact with the first surface 131 of the resistive heating plate 130 and the upper surface (i.e., the bearing surface 124) of the bottom plate 121, so that the oil guiding member 140 is arranged in the receiving cavity 123 of the atomizing bracket 120 smoothly. Specifically, the third surface 143 of the oil guiding member 140 is in contact with the upper surface of the hollowed portion 135 of the resistive heating plate 130 and the upper surface (i.e., the bearing surface 124) of the bottom plate 121. Preferably, the third surface 143 of the oil guiding member 140 is also in contact with the upper surface of each flat plate portion 134 of the resistive heating plate 130.

Referring to FIG. 11, each conductive pin 136 is in contact with the lower surface of the bottom plate 121. Each flat plate portion 134 is located on the upper surface of the bottom plate 121, and each flat plate portion 134 is located above a corresponding conductive pin 136. Each flat plate portion 134 and the corresponding conductive pin 136 are oppositely arranged on the upper and lower surfaces of the bottom plate 121. Each flat plate portion 134 and the corresponding conductive pin 136 are separated from each other by the bottom plate 121 of the atomizing bracket 120, and each flat plate portion 134 and the corresponding conductive pin 136 are connected through the bending portion 139. The flat plate portion 134, the hollowed portion 135, the conductive pin 136 and the bending portion 139 are an integral structure.

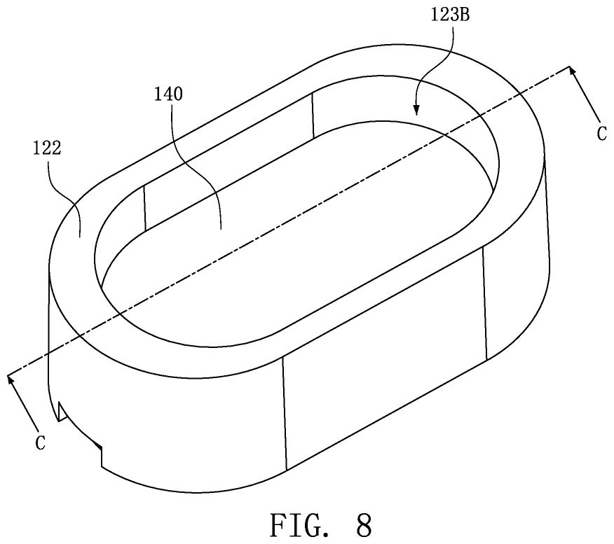

Referring to FIG. 8 and FIG. 11, the oil guiding member 140 is completely contained in the receiving cavity 123, and the fourth surface 144 of the oil guiding member 140 is lower than the upper surface of the side wall 122 of the atomizing bracket 120, so that a hollow cavity 123B is formed in the atomizing bracket 120 and the hollow cavity 123B is surrounded by the fourth surface 144 of the oil guiding member 140 and the side wall 122 of the atomizing bracket 120.

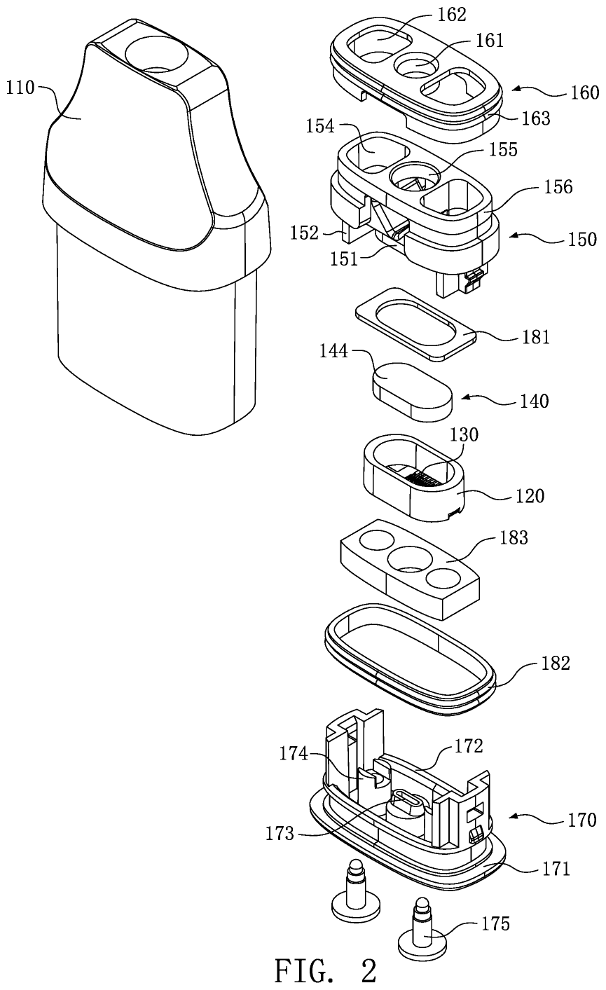

Referring to FIGS. 2, 3, 5 and 6, the atomizer 100 further includes an oil guiding bracket 150 received in the oil storage container 110. The oil guiding bracket 150 is arranged above the atomizing bracket 120. The lower end of the oil guiding bracket 150 is provided with an annular pressing wall 151, which extends into the hollow cavity 123B and abuts against the periphery of the fourth surface 144 of the oil guiding member 140. A downward pressure is applied to the oil guiding member 140 by the pressing wall 151, so that the oil guiding member 140 is sandwiched between the pressing wall 151 and the bottom plate 121 of the atomizing bracket 120 to prevent the oil guiding member 140 from loosening and displacement, and the oil guiding member 140 can better fit and contact with the resistive heating plate 130, so as to improve the atomization effect.

The lower end of the oil guiding bracket 150 is further provided with two baffle plates 152, which are arranged oppositely to each other. The pressing wall 151 is located between the two baffle plates 152 with a gap 153 being formed between the pressing wall 151 and the two baffle plates 152, and the side wall 122 of the atomizing bracket 120 is inserted into the gap 153. By limiting the side wall 122 of the atomizing bracket 120 within the gap 153, the atomizing bracket 120 can be stably installed in the atomizer 100.

A sealing pad 181 is further provided in the gap 153, and the sealing pad 181 is sandwiched between the upper surface of the side wall 122 of the atomizing bracket 120 and the bottom face of the oil guiding bracket 150. The sealing pad 181 has a sheet structure, and the middle of the sealing pad 181 is provided with a through hole (not labelled) for the pressing wall 151 to pass through. The sealing pad 181 can prevent the smoke oil absorbed into the receiving cavity 123 from leaking from the upper surface of the side wall 122.

The upper end of the oil guiding bracket 150 is provided with two first liquid inlet holes 154 on both sides. The oil storage container 110 is provided with an oil storage chamber 111 for storing smoke oil. Each first liquid inlet hole 154 communicates the oil storage chamber 111 with the oil guiding member 140, so that the smoke oil in the oil storage chamber 111 can be transmitted to the oil guiding member 140 through the first liquid inlet holes 154.

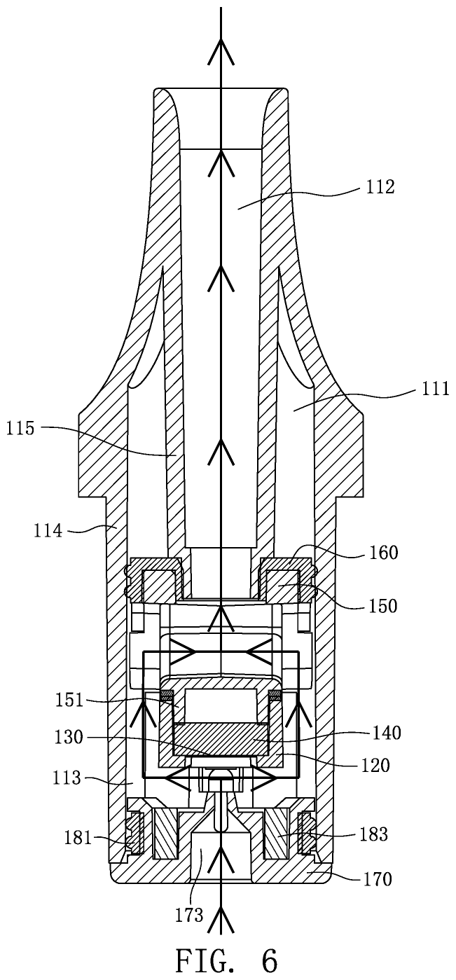

The upper end of the oil guiding bracket 150 is provided with a first air outlet hole 155 in the middle. The first air outlet hole 155 is located between the two first liquid inlet holes 154. The oil storage container 110 is provided with a smoke outlet channel 112 which is isolated from the oil storage chamber 111. An air outlet channel 113 (see FIG. 6) is formed between the atomizing bracket 120 and the oil storage container 110. The first air outlet hole 155 communicates the air outlet channel 113 with the smoke outlet channel 112, so that the airflow in the atomizer 100 can flow to the smoke outlet channel 112 through the air outlet channel 113 and the first air outlet hole 155.

The atomizer 100 further includes a sealing cover 160 received in the oil storage container 110, and the sealing cover 160 is arranged above the oil guiding bracket 150. The sealing cover 160 is provided with a second air outlet hole 161 in the middle. The second air outlet hole 161 communicates the first air outlet hole 155 with the smoke outlet channel 112, so that the airflow in the atomizer 100 can flow to the smoke outlet channel 112 through the air outlet channel 113, the first air outlet hole 155 and the second air outlet hole 161 in sequence. The sealing cover 160 is provided with two second liquid inlet holes 162 on both sides corresponding to the two first liquid inlet holes 154. Each second liquid inlet hole 162 communicates the oil storage chamber 111 with a corresponding first liquid inlet hole 154, so that the smoke oil in the oil storage chamber 111 can be transmitted to the oil guiding member 140 through the second liquid inlet holes 162 and the first liquid inlet holes 154 in sequence.

The oil storage container 110 includes an outer tube 114 and an inner tube 115 located in the outer tube 114. The lower end of the outer tube 114 is an open end, and the inner tube 115 is connected with the upper end of the outer tube 114. The oil storage chamber 111 is formed between the outer tube 114 and the inner tube 115. Specifically, the oil storage chamber 111 is an annular groove provided around the inner tube 115. The smoke outlet channel 112 is formed inside the inner tube 115, and the air outlet channel 113 is formed between the side wall 122 of the atomizing bracket 120 and the inner wall of the outer tube 114. In this embodiment, the inner tube 115 and the upper end of the outer tube 114 are integrated, that is, the inner tube 115 and the outer tube 114 are integrally formed.

The sealing cover 160 has a side wall 163, and the upper end of the oil guiding bracket 150 has a side wall 156. The side wall 163 of the sealing cover 160 is sandwiched between the side wall 156 at the upper end of the oil guiding bracket 150 and the inner wall of the outer tube 114. The lower end of the inner tube 115 is inserted into the second air outlet hole 161, so that the outer wall at the lower end of the inner tube 115 closely abuts against the sealing cover 160 to prevent the smoke oil in the oil storage chamber 111 from leaking.

The atomizer 100 further includes an atomizing base 170 arranged below the atomizing bracket 120 and installed at the open end of the outer tube 114. The atomizing base 170 includes a bottom plate 171 and a side wall 172 extending upward from the periphery of the bottom plate 171. The bottom plate 171 of the atomizing base 170 is provided with an air inlet hole 173. The external air enters the outer tube 114 through the air inlet hole 173, then carries the smoke generated by atomization to flow sequentially through the air outlet channel 113, the first air outlet hole 155, the second air outlet hole 161 and the smoke outlet channel 112, and finally is discharged out for the user to inhale.

The atomizer 100 further includes a sealing ring 182 received in the oil storage container 110. The sealing ring 182 has an annular structure. The sealing ring 182 is sandwiched between the side wall 172 of the atomizing base 170 and the inner wall of the outer tube 114 to prevent the smoke oil from leaking out from the open end at the lower end of the outer tube 114.

The inner surface of the bottom plate 171 of the atomizing base 170 extends upward to provide with two positioning posts 174. The atomizer 100 further includes two conductive electrodes 175. The two conductive electrodes 175 are respectively inserted into the two positioning posts 174, the upper ends of the two conductive electrodes 175 are respectively in electrical contact with the two conductive pins 136 of the resistive heating plate 130, and the lower ends of the two conductive electrodes 175 are exposed outside the oil storage container 110 to facilitate the electrical connection between the two conductive electrodes 175 and a power supply device (not shown).

The atomizer 100 further includes an oil absorbing member 183 received in the oil storage container 110. The oil absorbing member 183 has a block structure. The oil absorbing member 183 is arranged on the inner surface of the bottom plate 171 of the atomizing base 170 and is sleeved on the two positioning posts 174. The oil absorbing member 183 can absorb condensate or smoke oil generated during atomization to prevent the leakage of the condensate or smoke oil. The oil absorbing member 183 is an oil absorbing cotton or other material with oil absorbing function.

Referring to FIGS. 9-11, the middle of the bottom plate 121 of the atomizing bracket 120 is penetrated with the atomizing opening 126, the middle of the resistive heating plate 130 is hollowed to form the hollowed portion 135, and the hollowed portion 135 is arranged in alignment with the atomizing opening 126. The smoke generated by atomization can enter the airflow channel in the atomizer 100 through the hollowed portion 135 and the atomizing opening 126, and is taken away by the external air entering the atomizer 100 for the user to inhale.

When the atomizer 100 works, the smoke oil stored in the oil storage chamber 111 of the oil storage container 110 is guided to the fourth surface 144 of the oil guiding member 140 through the second liquid inlet holes 162 of the sealing cover 160 and the first liquid inlet holes 154 of the oil guiding bracket 150, and then is absorbed by the oil guiding member 140 and transmitted to the third surface 143 which is in close contact with the resistive heating plate 130, as shown by the liquid direction arrows in FIG. 5. The resistive heating plate 130 generates heat when energized to atomize the smoke oil in contact with the first surface 131 of the resistive heating plate 130 to form smoke, and the smoke formed by atomization enters the inner cavity of the atomizing base 170 through the hollowed portion 135 and the atomizing opening 126. The external air enters the inner cavity of the atomizing base 170 from the air inlet hole 173 of the atomizing base 170, then carries the smoke formed by atomization to flow sequentially through the air outlet channel 113, the first air outlet hole 155, the second air outlet hole 161 and the smoke outlet channel 112, and finally is discharged out for the user to inhale, as shown by the airflow direction arrows in FIG. 6.

In this embodiment, the resistive heating plate is combined with the atomizing bracket made by plastic, rubber or silicone to become a heating assembly. Such a heating assembly can realize automatic forming and production through the mold, and after forming, there is no need to go through cumbersome post-processing treatment as required by ceramics, to effectively improve the production efficiency and the product stability, and effectively ensure the quality consistency of the atomizing structure.

In this embodiment, the inner cavity of the heating assembly is installed with an oil guiding member, and the oil guiding bracket is then installed. Under the downward pressure of the oil guiding bracket, the oil guiding member is in close contact with the resistive heating plate of the heating assembly, so as to form an atomizing structure with heating capacity and oil guiding channel, thereby effectively improving the atomization effect and avoiding the generation of burning smell to affect the taste of smoking during atomization.

### Second Embodiment

Referring to FIGS. 12-15, a second embodiment of the present disclosure provides an atomizer 100, which includes an oil storage container 110, an atomizing bracket 120, a resistive heating plate 130 and an oil guiding member 140, wherein the atomizing bracket 120, the resistive heating plate 130 and the oil guiding member 140 are received in the oil storage container 110.

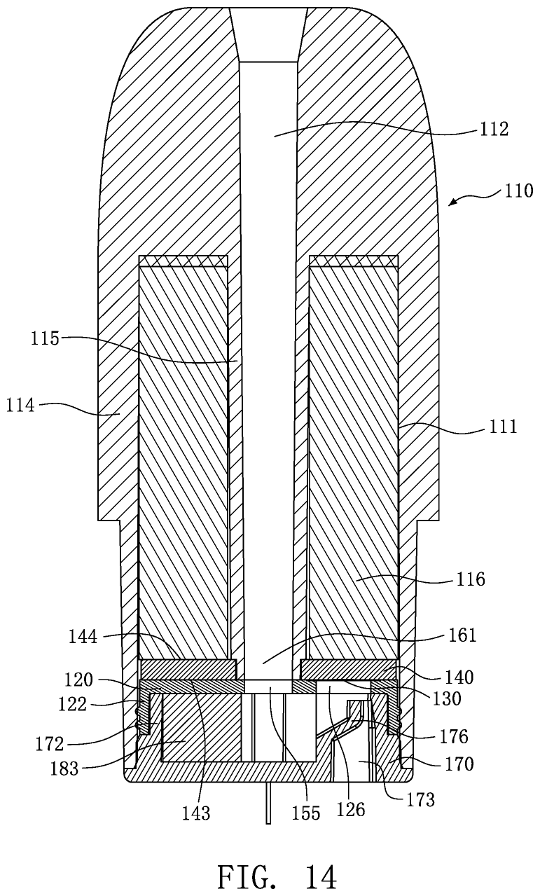

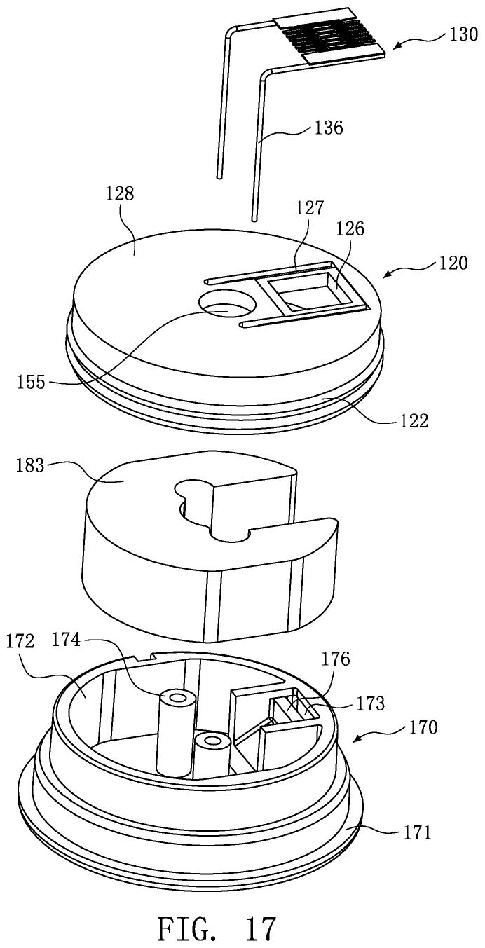

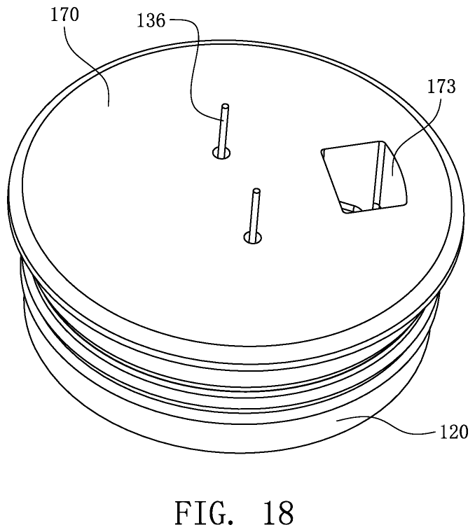

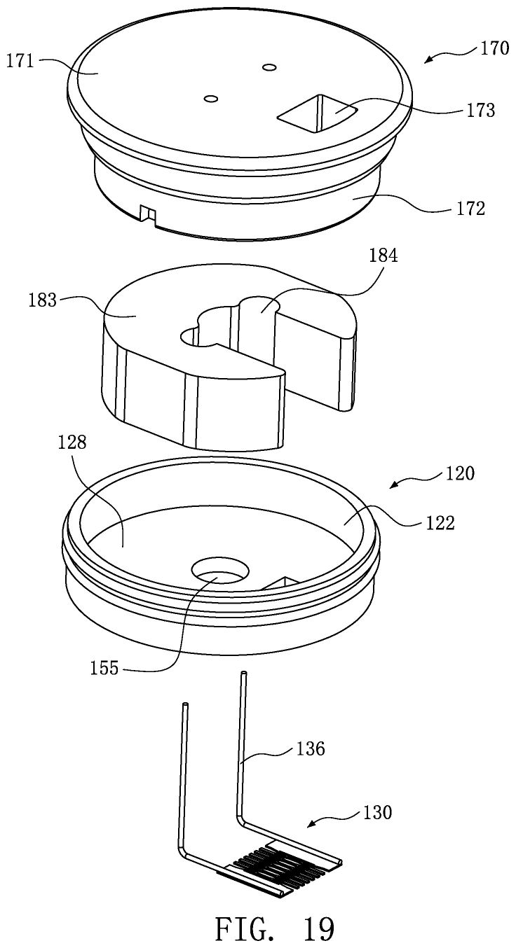

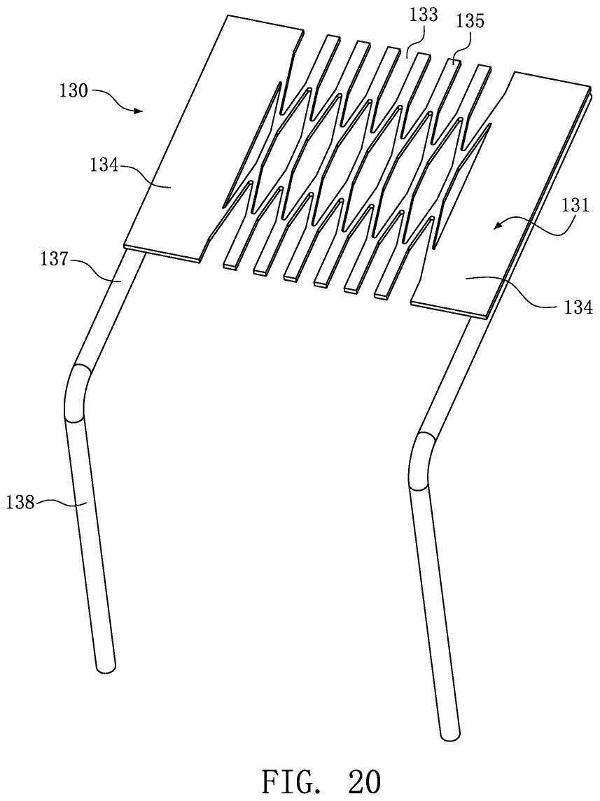

Referring to FIGS. 14-19, the resistive heating plate 130 is combined with the atomizing bracket 120, and the oil guiding member 140 is disposed on the resistive heating plate 130. The resistive heating plate 130 has a sheet structure, and the resistive heating plate 130 is made of a metal sheet. The resistive heating plate 130 includes a flat plate portion 134, a hollowed portion 135, a first surface 131 facing the oil guiding member 140 and a second surface 132 away from the oil guiding member 140, wherein the first surface 131 is the upper surface of the resistive heating plate 130 and the second surface 132 is the lower surface of the resistive heating plate 130. The atomizing bracket 120 includes an atomizing opening 126, and the atomizing opening 126 is aligned with the hollowed portion 135. The oil guiding member 140 includes a third surface 143 facing the resistive heating plate 130 and a fourth surface 144 away from the resistive heating plate 130, wherein the third surface 143 is the lower surface of the oil guiding member 140 and the fourth surface 144 is the upper surface of the oil guiding member 140. The third surface 143 of the oil guiding member 140 is in contact with the first surface 131 of the resistive heating plate 130.

In this embodiment, the resistive heating plate 130 is combined with the atomizing bracket 120, and then the oil guiding member 140 is directly in contact with the resistive heating plate 130. In this way, the assembly is simple, and the automatic assembly and production can be realized, which can effectively improve the production efficiency and product stability, and effectively ensure the quality consistency of the atomizing structure. Further, the resistive heating piece 130 is in full and close contact with the oil guiding member 140, which can effectively improve the atomization effect and avoid the influence of burning smell to affect the taste of smoking during atomization.

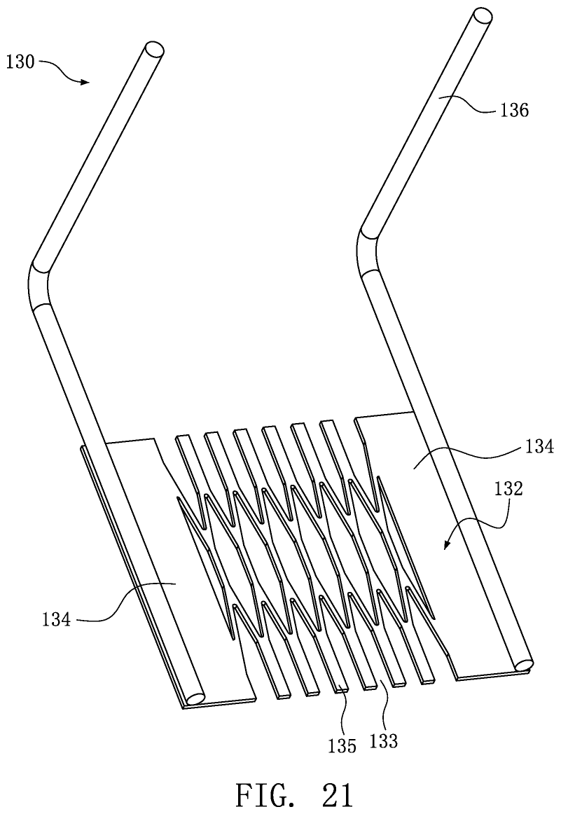

Referring to FIG. 20 and FIG. 21, specifically, the first surface 131 and the second surface 132 of the resistive heating plate 130 are flat surfaces, and the first surface 131 and the second surface 132 are parallel to each other.

Referring to FIG. 12 and FIG. 14, the oil guiding member 140 has a block structure, the third surface 143 and the fourth surface 144 are flat surfaces, and the third surface 143 and the fourth surface 144 are parallel to each other. The oil guiding member 140 can cause the smoke oil to be evenly absorbed and transmitted to the resistive heating plate 130, so as to improve the atomization effect. The oil guiding member 140 may be an oil guide cotton.

Referring to FIGS. 14-15 and FIGS. 20-21, a plurality of orifices 133 are provided in the middle of the resistive heating plate 130 to form a hollowed portion 135, so that the resistive heating plate 130 forms two flat plate portions 134 and a hollowed portion 135, and the hollowed portion 135 is located in the middle of the resistive heating plate 130. The two flat plate portions 134 and the hollowed portion 135 are located in the same plane, the two flat plate portions 134 are located on two opposite sides of the hollowed portion 135, the hollowed portion 135 is located between the two flat plate portions 134, and the two flat plate portions 134 are interconnected by the hollowed portion 135. The hollowed portion 135 forms a plurality of heating wires between adjacent orifices 133, and thus the hollowed portion 135 is the heating part of the resistive heating plate 130. The smoke generated by atomization can enter the airflow channel in the atomizer 100 through these orifices 133 and be taken away by the external air entering the atomizer 100 for the user to inhale.

Referring to FIGS. 14-21, the atomizing bracket 120 includes a top plate 128 and a side wall 122 extending downward from the periphery of the top plate 128. The resistive heating plate 130 further includes two conductive pins 136 electrically connected with the two flat plate portions 134 respectively. In this embodiment, each conductive pin 136 includes a horizontal part 137 and a vertical part 138, one end of the horizontal part 137 is connected with a corresponding flat plate portion 134, the vertical part 138 is formed by bending downward from the other end of the horizontal part 137, and the vertical part 138 extends downward to pass through the top plate 128. The upper surface of the atomizing bracket 120 is provided with an embedding slot 127, and the horizontal part 137 is arranged in the embedding slot 127, so that the resistive heating plate 130 is at least partially embedded in the top plate 128 of the atomizing bracket 120, so as to realize the combination of the resistive heating plate 130 and the atomizing bracket 120. The vertical part 138 being bent and extended downward facilitates the electrical connection with a power supply device (not shown). In this embodiment, the vertical part 138 and the horizontal portion 137 are perpendicular to each other and therefore form an included angle of 90 degrees.

The resistive heating plate 130 is made of metal. For example, the material of the resistive heating plate 130 may be nickel chromium alloy, iron chromium aluminum, S316L stainless steel and other alloy materials. The atomizing bracket 120 is made of plastic, rubber or silicone. As another combining method, the resistive heating plate 130 may also be combined with the atomizing bracket 120 by an insert molding process, so that the two flat plate portions 134 and the hollowed portion 135 are embedded in the atomizing bracket 120. Specifically, when forming the atomizing bracket 120, the resistive heating plate 130 is placed in a cavity of a mold (not shown), and then molten plastic, rubber or silicone is injected into the cavity of the mold, so that the molten plastic, rubber or silicone is coated on the periphery of the resistive heating plate 130, and after cooling, the atomizing bracket 120 is formed, so that the resistive heating plate 130 is at least partially embedded in the atomizer bracket 120.

The resistive heating plate 130 is combined with the atomizing bracket 120 to form a heating assembly.

Referring to FIGS. 14-19, the atomizing bracket 120 includes a top plate 128 and a side wall 122 extending downward from the periphery of the top plate 128. The resistive heating plate 130 is embedded in the top plate 128 of the atomizing bracket 120. The first surface 131 of the resistive heating plate 130 is located in the same plane with the upper surface of the top plate 128 of the atomizing bracket 120, and the third surface 143 of the oil guiding member 140 is also in contact with the upper surface of the top plate 128 of the atomizing bracket 120. The oil guiding member 140 is arranged independently of the atomizing bracket 120 and the resistive heating plate 130. The oil guiding member 140 has the ability to absorb smoke oil, but the atomizing bracket 120 does not have the ability to absorb smoke oil. The atomizing bracket 120 is used to combine the resistive heating plate 130 and support the oil guiding member 140.

The atomizing opening 126 is arranged on one side of the top plate 128 and penetrates the upper and lower surfaces of the top plate 128. The atomizing opening 126 is aligned with the hollowed portion 135. That is, the hollowed portion 135 is arranged at the position corresponding to the atomizing opening 126 so that the hollowed portion 135 is aligned with the atomizing opening 126. The hollowed portion 135 is located above the atomizing opening 126, and the hollowed portion 135 spans over the atomizing opening 126.

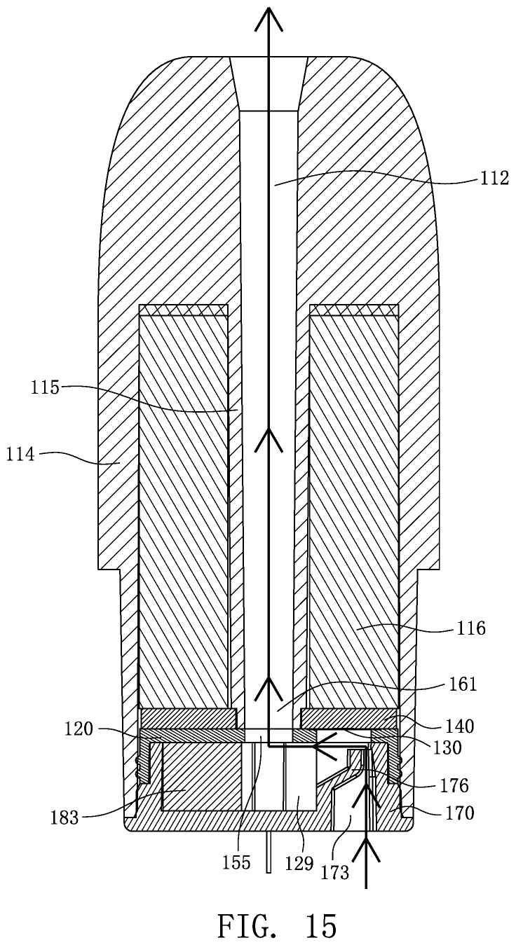

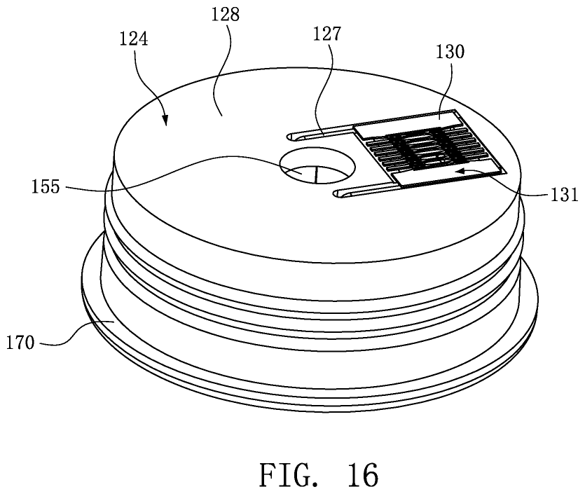

Referring to FIG. 14 and FIG. 15, the second surface 132 of the resistive heating plate 130 is higher than the lower surface of the top plate 128 of the atomizing bracket 120, and a specific distance is formed between them, preferably 0.5 mm-2.0 mm.

Referring to FIGS. 14-19, the top plate 128 of the atomizing bracket 120 includes a bearing surface 124 in contact with the third surface 143 of the oil guiding member 140. Specifically, the bearing surface 124 is the upper surface of the top plate 128. The first surface 131 of the resistive heating plate 130 is located in the same plane with the upper surface of the top plate 128. The third surface 143 of the oil guiding member 140 is in contact with the first surface 131 of the resistive heating plate 130 and the upper surface (i.e., the bearing surface 124) of the top plate 128, so that the oil guiding member 140 is smoothly arranged on the upper surface of the top plate 128.

In other embodiments, the first surface 131 of the resistive heating plate 130 may also be slightly higher than the upper surface of the top plate 128, so that the first surface 131 of the resistive heating plate 130 can be slightly embedded into the oil guiding member 140 under the gravity of the oil storage member 116, so as to improve the contact area and liquid conduction effect between the resistive heating plate 130 and the oil guiding member 140.

Referring to FIG. 12 and FIGS. 14-15, the oil storage container 110 is provided with an oil storage chamber 111, and an oil storage member 116 for storing smoke oil is provided in the oil storage chamber 111. The oil storage member 116 is a hollow cylinder. The shape of the oil storage member 116 matches the oil storage chamber 111, so that the oil storage member 116 can be fittingly received in the oil storage chamber 111. The lower surface of the oil storage member 116 is in contact with the fourth surface 144 of the oil guiding member 140. Due to the gravity applied to the oil guiding member 140 by the oil storage member 116, the oil guiding member 140 is sandwiched between the oil storage member 116 and the top plate 128 of the atomizing bracket 120, so that the oil guiding member 140 is in close contact with the resistive heating plate 130, so as to improve the atomization effect. The oil storage member 116 may be oil storage cotton or other material with oil storage function.

The top plate 128 of the atomizing bracket 120 is provided with a first air outlet hole 155 in the middle. The oil guiding member 140 is provided with a second air outlet hole 161 in the middle corresponding to the first air outlet hole 155. The oil storage container 110 is provided with a smoke outlet channel 112 which is isolated from the oil storage chamber 111. The second air outlet hole 161 communicates the first air outlet hole 155 with the smoke outlet channel 112, so that the airflow in the atomizer 100 can flow to the smoke outlet channel 112 through the first air outlet hole 155 and the second air outlet hole 161 in sequence.

The oil storage container 110 includes an outer tube 114 and an inner tube 115 located in the outer tube 114. The lower end of the outer tube 114 is an open end, and the inner tube 115 is connected with the upper end of the outer tube 114. The oil storage chamber 111 is formed between the outer tube 114 and the inner tube 115. Specifically, the oil storage chamber 111 is an annular groove provided around the inner tube 115. The smoke outlet channel 112 is formed inside the inner tube 115. In this embodiment, the inner tube 115 and the upper end of the outer tube 114 are integrated, that is, the inner tube 115 and the outer tube 114 are integrally formed. The oil storage member 116 is a hollow cylinder, the middle of the oil storage member 116 is penetrated with a through hole 117, and the oil storage member 116 is sleeved on the inner tube 115 through the through hole 117.

The atomizer 100 further includes an atomizing base 170 arranged below the atomizing bracket 120 and installed at the open end of the outer tube 114. The atomizing base 170 includes a bottom plate 171 and a side wall 172 extending upward from the periphery of the bottom plate 171. The side wall 122 of the atomizing bracket 120 is sandwiched between the side wall 172 of the atomizing base 170 and the inner wall of the outer tube 114. The lower end of the inner tube 115 is inserted into the second air outlet hole 161 and abuts against the upper surface of the top plate 128 of the atomizing bracket 120. Preferably, in this embodiment, the atomizing bracket 120 is made of rubber or silicone, such that the atomizing bracket 120 is soft and has a sealing function. Therefore, through the atomizing bracket 120, the smoke oil in the oil storage chamber 111 can be prevented from leaking from the open end at the lower end of the outer tube 114, and there is no need to set the sealing cover 160 as described in the above first embodiment, so that the structure is simpler.

Referring to FIG. 12 and FIGS. 14-17, the inner surface of the bottom plate 171 of the atomizing base 170 extends upward to provide with two positioning posts 174. The vertical parts 138 of the two conductive pins 136 respectively pass through the two positioning posts 174 and are exposed outside the oil storage container 110 to facilitate the electrical connection between the exposed conductive pins 136 and the power supply device (not shown).

In the atomizing base 170, an accommodating cavity 129 is provided. The accommodating cavity 129 is formed between the bottom plate 171 of the atomizing base 170 and the top plate 128 of the atomizing bracket 120. An oil absorbing member 183 is arranged in the accommodating cavity 129. Specifically, the oil absorbing member 183 is U-shaped, and the oil absorbing member 183 is provided with a cutout 184 corresponding to the position of the first air outlet hole 155. Therefore, the oil absorbing member 183 only occupies a portion of the inner cavity of the atomizing base 170. The oil absorbing member 183 can absorb condensate or smoke oil generated during atomization to prevent the leakage of the condensate or smoke oil. The oil absorbing member 183 is an oil absorbing cotton or other material having an oil absorbing function.

Referring to FIGS. 14-15 and FIGS. 17-19, the bottom plate 171 of the atomizing base 170 is provided with an air inlet hole 173. The external air enters the accommodating cavity 129 through the air inlet hole 173, then carries the smoke generated by atomization to flow sequentially through the first air outlet hole 155, the second air outlet hole 161 and the smoke outlet channel 112, and finally is discharged for the user to inhale.

Referring to FIGS. 14-15 and FIG. 17, the inner surface of the bottom plate 171 of the atomizing base 170 extends obliquely towards the side wall 172 of the atomizing base 170 to form a guiding tab 176. The guiding tab 176 is located directly below the atomizing opening 126, and the air inlet hole 173 is formed between the guiding tab 176 and the side wall 172 of the atomizing base 170. The condensate or smoke oil generated during atomization can be guided by the guiding tab 176 to the accommodating cavity 129 for collection and absorbed by the oil absorbing member 183 located in the accommodating cavity 129, so as to prevent the leakage of the condensate or smoke oil through the air inlet hole 173.

Referring to FIG. 12 and FIGS. 14-15, one side of the top plate 128 of the atomizing bracket 120 is penetrated with the atomizing opening 126, the middle of the resistive heating plate 130 is hollowed to form the hollowed portion 135, and the hollowed portion 135 is arranged in alignment with the atomizing opening 126. The smoke generated by atomization can enter the airflow channel in the atomizer 100 through the hollowed portion 135 and the atomizing opening 126, and is taken away by the external air entering the atomizer 100 for the user to inhale.

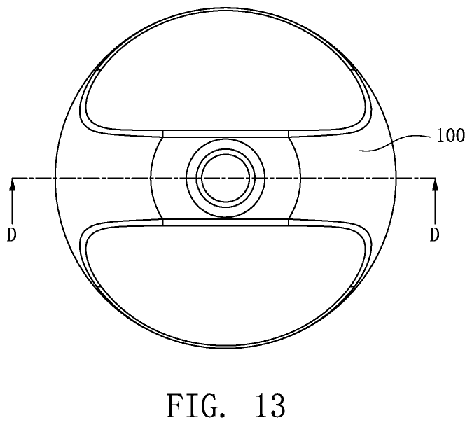

When the atomizer 100 works, the smoke oil stored by the oil storage member 116 in the oil storage container 110 is guided to the oil guiding member 140. After being absorbed by the oil guiding member 140, the smoke oil is then transmitted to the third surface 143 which is in close contact with the resistive heating plate 130. The resistive heating plate 130 generates heat when energized to atomize the smoke oil in contact with the first surface 131 of the resistive heating plate 130 to form smoke, and the smoke formed by atomization enters the accommodating cavity 129 of the atomizing base 170 through the hollowed portion 135 and the atomizing opening 126. The external air enters the accommodating cavity 129 from the air inlet hole 173 of the atomizing base 170, then carries the smoke formed by atomization to flow sequentially through the first air outlet hole 155, the second air outlet hole 161 and the smoke outlet channel 112, and finally is discharged out for the user to inhale, as shown by the airflow direction arrows in FIG. 13.

In this embodiment, the resistive heating plate is combined with the upper surface of the atomizing bracket to form a heating assembly. Such a heating assembly is simple to assemble and can realize automatic assembly and production. The assembly process does not need to go through the complicated assembly process of wrapping oil guide cotton on external surface of resistive heating body as required by vertical cotton core, to effectively improve the production efficiency and product stability, and effectively ensure the quality consistency of the atomizing structure.

In this embodiment, the oil guiding member is sandwiched between the oil storage member and the heating assembly in the oil storage container. Under the gravity of the oil storage member, the oil guiding member is in close contact with the resistive heating plate of the heating assembly, so as to form an atomizing structure with heating capacity and oil guiding channel, thereby effectively improving the atomization effect and avoiding the generation of burning smell to affect the taste of smoking during atomization.

The present disclosure further provides an electronic cigarette, including the above atomizer.

The electronic cigarette further includes a power supply device (not shown), and the power supply device is electrically connected with the atomizer. The power supply device contains a battery, and the power supply device provides the power required for the working of the atomizer.

The above are only the preferred embodiments of the present disclosure and are not intended to limit the present disclosure. Any modifications, equivalent replacements, improvements, etc. made within the spirit and principle of the present disclosure shall be included in the protection scope of the present disclosure.

1. A heating assembly for an atomizer, comprising a resistive heating plate and an atomizing bracket, wherein the resistive heating plate is combined with the atomizing bracket, the resistive heating plate comprises a flat plate portion and a hollowed portion, the atomizing bracket comprises an atomizing opening, and the atomizing opening is aligned with the hollowed portion.

2. The heating assembly according to claim 1, wherein a plurality of orifices are provided in a middle of the resistive heating plate to form the hollowed portion, the quantity of the flat plate portion is two and the two flat plate portions are respectively located on two opposite sides of the hollowed portion, the hollowed portion is located between the two flat plate portions, and the two flat plate portions are interconnected by the hollowed portion.

3. The heating assembly according to claim 2, wherein the resistive heating plate further comprises two conductive pins, the two conductive pins are arranged respectively corresponding to the two flat plate portions, each conductive pin and corresponding flat plate portion are separated from each other by the atomizing bracket, each conductive pin is connected with the corresponding flat plate portion through a bending portion, the two conductive pins are each located at a lower surface of the atomizing bracket and exposed outside the atomizing bracket, and the two conductive pins are each in contact with the lower surface of the atomizing bracket.

4. The heating assembly according to claim 2, wherein the atomizing bracket comprises a bottom plate and a side wall extending upward from a periphery of the bottom plate, a receiving cavity for receiving the oil guiding member is formed in the atomizing bracket, the bottom plate of the atomizing bracket is penetrated with the atomizing opening, two ends of the resistive heating plate extend out of the atomizing bracket and are respectively bent downward and inward to form two conductive pins, the two conductive pins are respectively connected with the two flat plate portions and are respectively located below the two flat plate portions, and the two conductive pins are each in contact with a lower surface of the bottom plate.

5. The heating assembly according to claim 1, wherein the atomizing bracket comprises a bottom plate and a side wall extending upward from a periphery of the bottom plate, a receiving cavity for receiving the oil guiding member is formed in the atomizing bracket, the bottom plate of the atomizing bracket is penetrated with the atomizing opening, two ends of the resistive heating plate extend out of the atomizing bracket and are respectively bent downward and inward to form two conductive pins, and the two conductive pins are exposed on a lower surface of the bottom plate.

6. The heating assembly according to claim 4 or 5, wherein the resistive heating plate comprises a first surface and a second surface, the first surface is an upper surface of the resistive heating plate, the second surface is a lower surface of the resistive heating plate, the first surface and the second surface are flat surfaces, the first surface is located in the same plane with an upper surface of the bottom plate, the first surface of the resistive heating plate and the upper surface of the bottom plate are used for contacting with an oil guiding member.

7. The heating assembly according to claim 4 or 5, wherein an upper surface of the hollowed portion is located in the same plane with an upper surface of the bottom plate, the atomizing opening is arranged in a middle of the bottom plate and penetrates upper and lower surfaces of the bottom plate, the atomizing opening is in communication with the receiving cavity, and the hollowed portion spans over the atomizing opening.

8. The heating assembly according to claim 2, wherein the atomizing bracket comprises a top plate and a side wall extending downward from a periphery of the top plate, and the top plate is penetrated with the atomizing opening.

9. The heating assembly according to claim 8, wherein the resistive heating plate further comprises two conductive pins, the two conductive pins are respectively connected with the two flat plate portions, each conductive pin comprises a horizontal part and a vertical part, one end of the horizontal part is connected with the flat plate portion, the vertical part is bent downward from the other end of the horizontal part, and the vertical part extends downward to pass through the top plate.

10. The heating assembly according to claim 8, wherein the resistive heating plate comprises a first surface and a second surface, the first surface is an upper surface of the resistive heating plate, the second surface is a lower surface of the resistive heating plate, the first surface and the second surface are flat surfaces, the first surface of the resistive heating plate is located in the same plane with or slightly higher than an upper surface of the top plate, the first surface of the resistive heating plate and the upper surface of the top plate are used for contacting with an oil guiding member.

11. The heating assembly according to claim 1, wherein the resistive heating plate is made of metal, the atomizing bracket is made of plastic, rubber or silicone, the resistive heating plate is combined with the atomizing bracket through an insert molding process, so that the resistive heating plate is at least partially embedded in the atomizing bracket, the hollowed portion is exposed and located above the atomizing opening, the two flat plate portions and the hollowed portion are located in the same plane.

12. An atomizer comprising an atomizing bracket, a resistive heating plate and an oil guiding member, wherein the resistive heating plate is combined with the atomizing bracket, the resistive heating plate comprises a flat plate portion and a hollowed portion, the atomizing bracket comprises an atomizing opening, the resistive heating plate comprises a first surface facing the oil guiding member and a second surface away from the oil guiding member, the oil guiding member comprises a third surface facing the resistive heating plate and a fourth surface away from the resistive heating plate, the oil guiding member is disposed on the resistive heating plate, the third surface of the oil guiding member is in contact with the first surface of the resistive heating plate, and the atomizing opening is aligned with the hollowed portion.

13. The atomizer according to claim 12, wherein the oil guiding member is an oil guide cotton, the oil guiding member has a block structure, and the third surface of the oil guiding member and the first surface of the resistive heating plate are flat surfaces.

14. The atomizer according to claim 12, wherein a plurality of orifices are provided in a middle of the resistive heating plate to form the hollowed portion, the quantity of the flat plate portion is two and the two flat plate portions are respectively located on two opposite sides of the hollowed portion, the hollowed portion is located between the two flat plate portions, and the two flat plate portions are interconnected by the hollowed portion.

15. The atomizer according to claim 14, wherein the resistive heating plate further comprises two conductive pins, the two conductive pins are arranged respectively corresponding to the two flat plate portions, each conductive pin and corresponding flat plate portion are separated from each other by the atomizing bracket, each conductive pin is connected with the corresponding flat plate portion through a bending portion, the two conductive pins are each located at a lower surface of the atomizing bracket and exposed outside the atomizing bracket, and the two conductive pins are each in contact with the lower surface of the atomizing bracket.

16. The atomizer according to claim 14, wherein the atomizing bracket comprises a bottom plate and a side wall extending upward from a periphery of the bottom plate, a receiving cavity is formed in the atomizing bracket, the oil guiding member is smoothly arranged in the receiving cavity, and the bottom plate of the atomizing bracket is penetrated with the atomizing opening.

17. The atomizer according to claim 16, wherein two ends of the resistive heating plate respectively extend out of the atomizing bracket and are respectively bent downward and inward to form two conductive pins, the two conductive pins are respectively connected with the two flat plate portions and are respectively located below the two flat plate portions, and the two conductive pins are each in contact with a lower surface of the bottom plate.

18. The atomizer according to claim 16, wherein two ends of the resistive heating plate extend out of the atomizing bracket and are respectively bent downward and inward to form two conductive pins, and the two conductive pins are exposed on a lower surface of the bottom plate.

19. The atomizer according to claim 16, wherein the first surface and the second surface are flat surfaces, the first surface is located in the same plane with an upper surface of the bottom plate, and the third surface of the oil guiding member is in contact with the first surface and the upper surface of the bottom plate.

20. The atomizer according to claim 16, wherein an upper surface of the hollowed portion is located in the same plane with an upper surface of the bottom plate, the atomizing opening is arranged in a middle of the bottom plate and penetrates upper and lower surfaces of the bottom plate, the atomizing opening is in communication with the receiving cavity, the hollowed portion spans over the atomizing opening, and the third surface of the oil guiding member is in contact with the upper surface of the hollowed portion and the upper surface of the bottom plate.

21. The atomizer according to claim 16, wherein the oil guiding member is completely contained in the receiving cavity, and the fourth surface of the oil guiding member is lower than an upper surface of the side wall of the atomizing bracket, so that a hollow cavity is formed in the atomizing bracket and the hollow cavity is surrounded by the fourth surface of the oil guiding member and the side wall of the atomizing bracket in the atomizing bracket.

22. The atomizer according to claim 21, wherein the atomizer further includes an oil guiding bracket, the oil guiding bracket is arranged above the atomizing bracket, a lower end of the oil guiding bracket is provided with an annular pressing wall, and the pressing wall extends into the hollow cavity and abuts against a periphery of the fourth surface of the oil guiding member.

23. The atomizer according to claim 22, wherein the lower end of the oil guiding bracket is further provided with two baffle plates arranged oppositely to each other, the pressing wall is located between the two baffle plates, a gap is formed between the pressing wall and the two baffle plates, and the side wall of the atomizing bracket is inserted into the gap.

24. The atomizer according to claim 22, wherein an upper end of the oil guiding bracket is provided with two first liquid inlet holes on both sides, the atomizer further comprises an oil storage container, the oil storage container is provided with an oil storage chamber for storing smoke oil, and each first liquid inlet hole communicates the oil storage chamber with the oil guiding member.

25. The atomizer according to claim 24, wherein the upper end of the oil guiding bracket is provided with a first air outlet hole in the middle, and the oil storage container is provided with a smoke outlet channel isolated from the oil storage chamber, an air outlet channel is formed between the atomizing bracket and the oil storage container, and the first air outlet hole communicates the air outlet channel with the smoke outlet channel.

26. The atomizer according to claim 25, wherein the atomizer further comprises a sealing cover, the sealing cover is arranged above the oil guiding bracket, the sealing cover is provided with a second air outlet hole in the middle, the second air outlet hole communicates the first air outlet hole with the smoke outlet channel, the sealing cover is provided with two second liquid inlet holes on both sides corresponding to the two first liquid inlet holes, and each second liquid inlet hole communicates the oil storage chamber with a corresponding first liquid inlet hole.

27. The atomizer according to claim 25, wherein the oil storage container comprises an outer tube and an inner tube located in the outer tube, a lower end of the outer tube is an open end, and the inner tube is connected with an upper end of the outer tube, the oil storage chamber is formed between the outer tube and the inner tube, the smoke outlet channel is formed inside the inner tube, and the air outlet channel is formed between the side wall of the atomizing bracket and an inner wall of the outer tube.

28. The atomizer according to claim 27, wherein the sealing cover has a side wall, the upper end of the oil guiding bracket has a side wall, the side wall of the sealing cover is sandwiched between the side wall of the oil guiding bracket and the inner wall of the outer tube, a lower end of the inner tube is inserted into the second air outlet hole, so that the outer wall at the lower end of the inner tube is closely abuts against the sealing cover.

29. The atomizer according to claim 27, wherein the atomizer further comprises an atomizing base, the atomizing base is arranged below the atomizing bracket, the atomizing base is installed at the open end of the outer tube, the atomizing base comprises a bottom plate and a side wall extending upward from a periphery of the bottom plate, the bottom plate of the atomizing base is provided with an air inlet hole, wherein the external air enters the outer tube from the air inlet hole, carries the smoke generated by atomization, and is discharged out through the air outlet channel, the first air outlet hole, the second air outlet hole and the smoke outlet channel.

30. The atomizer according to claim 29, wherein an inner surface of the bottom plate of the atomizing base extends upward to provide with two positioning posts, the atomizer further comprises two conductive electrodes, the two conductive electrodes are respectively inserted into the two positioning posts and upper ends of the two conductive electrodes are respectively in electrical contact with the two conductive pins of the resistive heating plate, the atomizer further comprises an oil absorbing member arranged on the inner surface of the bottom plate of the atomizing base and sleeved on the two positioning posts.

31. The atomizer according to claim 14, wherein the atomizing bracket comprises a top plate and a side wall extending downward from a periphery of the top plate, the first surface of the resistive heating plate is located in the same plane with or slightly higher than an upper surface of the top plate, and the top plate is penetrated with the atomizing opening.

32. The atomizer according to claim 31, wherein the resistive heating plate further comprises two conductive pins, the two conductive pins are respectively connected with the two flat plate portions, each conductive pin includes a horizontal part and a vertical part, one end of the horizontal part is connected with the flat plate portion, and the vertical part is bent downward from the other end of the horizontal part, the vertical part extends downward to pass through the top plate, the upper surface of the top plate is provided with an embedding slot, and the horizontal part of each conductive pin is embedded in the embedding slot.

33. The atomizer according to claim 32, wherein the atomizer further comprises an oil storage container, the oil storage container is provided with an oil storage chamber, an oil storage member for storing smoke oil is provided in the oil storage chamber, and a lower surface of the oil storage member is in contact with the fourth surface of the oil guiding member.

34. The atomizer according to claim 33, wherein the top plate of the atomizing bracket is provided with a first air outlet hole in the middle, the oil guiding member is provided with a second air outlet hole in the middle corresponding to the first air outlet hole, the oil storage container is provided with a smoke outlet channel isolated from the oil storage chamber, the second air outlet hole communicates the first air outlet hole with the smoke outlet channel.

35. The atomizer according to claim 34, wherein the oil storage container comprises an outer tube and an inner tube located in the outer tube, a lower end of the outer tube is an open end, the inner tube is connected with an upper end of the outer tube, the oil storage chamber is formed between the outer tube and the inner tube, and the smoke outlet channel is formed inside the inner tube.

36. The atomizer according to claim 35, wherein the oil storage member is a hollow cylinder, a middle of the oil storage member is penetrated with a through hole, and the oil storage member is sleeved on the inner tube through the through hole.

37. The atomizer according to claim 35, wherein the atomizer further comprises an atomizing base, the atomizing base is installed at the open end of the outer tube, the atomizing base comprises a bottom plate and a side wall extending upward from a periphery of the bottom plate, the side wall of the atomizing bracket is sandwiched between the side wall of the atomizing base and an inner wall of the outer tube, and a lower end of the inner tube is inserted into the second air outlet hole and abuts against the upper surface of the top plate of the atomizing bracket.

38. The atomizer according to claim 37, wherein an accommodating cavity is provided in the atomizing base and formed between the bottom plate of the atomizing base and the top plate of the atomizing bracket, the bottom plate of the atomizing base is provided with an air inlet hole, wherein the external air enters the accommodating cavity from the air inlet hole, carries the smoke generated by atomization, and is discharged out through the first air outlet hole, the second air outlet hole and the smoke outlet channel.

39. The atomizer according to claim 38, wherein an inner surface of the bottom plate of the atomizing base extends obliquely towards the side wall of the atomizing base to form a guiding tab, the guiding tab is located directly below the atomizing opening, and the air inlet hole is formed between the guiding tab and the side wall of the atomizing base.

40. The atomizer according to claim 12, wherein the resistive heating plate is made of metal, and the atomizing bracket is made of plastic, rubber or silicone, the resistive heating plate is combined with the atomizing bracket through an insert molding process, so that the resistive heating plate is at least partially embedded in the atomizing bracket, the hollowed portion is located above the atomizing opening, the two flat plate portions and the hollowed portion are located in the same plane.

41. An electronic cigarette comprising an atomizer according to any one of claims 12 to 40.
